(19) United States
(12) Patent Application Publication
(10) Pub. No.: US 2010/0084984 A1
(43) Pub. Date: Apr. 8, 2010

(54) Energy-Saving LED-Based Lighting Device

(75) Inventors: Noel Leon Rovira, Monterrey (MX); Norma Frida Roffe Samaniego, Monterrey (MX); Manuel Mereno Rico, Monterrey (MX); Juan Pablo Hurtado Pacheco, Guayaquil (EC); Olivia Maricela Barron Cano, San Nicolas de los Garza (MX)

Correspondence Address: BAKER & MCKENZIE LLP, Pennzoil Place, South Tower, 711 Louisiana, Suite 3400, HOUSTON, TX, 77002-2716, US

(73) Assignee: Institutio Tecnologico y de estudios Superiores de Monterrey, Monterrey (MX)

(21) Appl. No.: 12/529,698

(22) PCT Filed: Feb. 25, 2008
(86) PCT No.: PCT/MX2008/000027

§ 371 Date: Sep. 2, 2009

(30) Foreign Application Priority Data
Mar. 2, 2007 (MX) MX/A/2007/002578

(51) Int. Cl. H05B 37/02

(52) U.S. Cl. 315/210

(57) ABSTRACT

This invention describes a lighting device with low energy consumption, which is made up of light emitting diodes known by the English acronym of LEDs, that use the technique known as “scanning”; with the purpose of reducing the consumption of energy required for lighting. Said scanning is performed by an efficient circuit that determines the sequence and time required for the activation of each LED or group of LEDs. The invention does not limit itself to only using LEDs, other types of elements for control may be used that may be sequenced without altering its operation or useful life. In this case, the speed that may support the LEDs is taken advantage of and that is higher than can be seen by the human eye, where each LED or group of LEDs are turned on and off at a frequency that is imperceptible by the human eye.

Solutions are also presented to reduce the voltage by electronic means and rectification of the current using the LEDs themselves that intervene in the lighting.

### OBJECT OF THE INVENTION

The invention described herein is a lighting device whose lighting source is made up of light emitting diodes (known as LED by its English acronym). This lighting device may be connected to any socket into which a conventional light bulb may be connected and also offers a variation that consists of being able to connect it to photovoltaic cell-powered batteries, even directly to the photovoltaic cells or to any direct current voltage source. The lighting device contains an LED network distributed in arrangements which may be linear, matrix, circular, or any other type of standard or non-standard arrangements. These LEDs are connected individually or in groups according to the amount of LEDs placed in the device and the need for lighting required by the user.

The main objective of this invention is to reduce the consumption of electric power necessary for lighting and to produce efficient lighting. This is accomplished because the LED array only lights one or a group of LEDs at a time. This is performed through the technique called “scanning” by our research group through which the LEDs light up and turn off consecutively, either one by one, or group by group. A group is made up by two or more LEDs. This turning on and turning off is carried out at a frequency that is imperceptible to the human eye, which creates the perception that the LED array is constantly on. Consequently, the LEDs of the lighting device appear to always be on but the energy consumed is proportional to the number of LEDs which are on resulting in an energy consumption which is 80% less than a conventional light bulb.

### BACKGROUND

This invention refers to a technology to generate lighting with low energy consumption. More specifically, the invention which is disclosed herein is a lighting device made up of a network of LEDs.

It is generally known that the current resources for electric power generation in the world are very limited, and therefore, it is vital to consume as little energy as possible, for financial reasons as well as to preserve the environment.

And with the purpose of finding a solution, primarily for the problem of lighting, different types of lighting devices have been developed, among which we may mention conventional devices, such as for example, the incandescent light bulb described in the publication: WO/2006/070190, which is low in cost, but very inefficient and fragile.

After attempting to reduce high energy consumption other devices have been developed such as that described in the publication: WO/2006/006097 which describes a compact fluorescent lamp, that with a principal similar to its antecedents uses inert gas which, in the presence of electricity, lights up; in general this lighting device is more efficient than the incandescent light bulb because it does make energy saving possible, however, the fluorescent bulb or tube requires ballasts and lighters which makes them more complicated and expensive, together with the fact that they are generally voluminous and fragile.

Another variety is the energy saving light which is known as the high-intensity discharge (HID—by its English acronym) lamp, such as the one described in U.S. Pat. No. 4,431,942; these lamps achieve higher efficiency than the fluorescent lamps, although they have the disadvantage of a high level of ultraviolet light emissions, which requires special filters. They also have the disadvantage of requiring ballasts and lighting aids similar to the fluorescent lamps described in U.S. Pat. No. 5,339,005. Another disadvantage of the HID lamp is that they require power factor correction as mentioned in U.S. Pat. No. 7,078,870. HID lamps are also susceptible to an elevation in their noise level due to acoustical resonance, which requires special measures such as those described in U.S. Pat. No. 7,078,870. The use of HID lamps has spread to automotive lights, as well as in places where large area lighting requires high intensity illumination.

One more variety focused on saving electric power, are light emitting diodes (LED); LEDs represent an advance in the technology, because they consume up to 80% less energy that incandescent lamps because they do not generate heat thanks to their size, but; in the case of white light, the level of efficiency of fluorescent lamps has not yet been reached. Even though competitive levels of efficiency were envisaged in their development. One characteristic of an LED lighting device, is that as light emitting diodes they may be used as part of the electronics required to rectify the current, reducing in this way the total cost. As shown in the application of patent MXNL05000079, in which LEDs are used to rectify the alternating current of an electrical network socket. This concept is also used in this patent for said purpose, however this invention differs from patent MXNL05000079 in that in said patent the LED array turn on and off all the 120 Hz frequencies (60 Hz×2 due to the fact that the diode bridge changes the frequency). In this invention, there is a digital logic stage, which enables the ability to exert special control on portions of the total of LEDs, which results in greater energy savings.

In this invention, the LEDs serve a double purpose, the first of these as lighting devices and additionally, to rectify the alternating current, thus impacting a reduction in cost. Below we will make a review of patents related to LED lighting devices, such as U.S. Pat. No. 6,016,038 which claims an apparatus to generate light, made up by one or more LEDs, a terminal for connection to a source, and a processor that generates signals through which the intensity or the color of the LEDs may be changed; another example is U.S. Pat. No. 6,149,283 that consists of a lamp made up by a line of blue, red, green LEDs, and that are arranged in such a way that the resulting light is white in color and that may be connected like a conventional light bulb, however its objective is limited to lighting without taking into consideration any reduction in cost. On the other hand, U.S. Pat. No. 6,227,679 claims an LED light bulb designed for general lighting and various other types of lighting, for example, decorative lamps and traffic lights among other applications; this light bulb includes a conical base with two circular openings, the first being of a greater diameter than the second; a flat disk inserted in the first opening, where the circuitry and the LEDs are found, and circuitry designed to provide current to the LEDs. This patent focuses on lighting but not in a special configuration as that which we are presenting and which is the reason for this invention. U.S. Pat. No. 6,268,801 claims a method to adjust a traffic signal by substituting the conventional light bulb used with a module that contains light emitting diodes, a power source connected to the LEDs and cables that connect the power source to a screw in light bulb, however they do not use LEDs for rectification nor do they show an LED array, as in this application, which are laid out in the form of a network.

After mentioning some patents that describe LED lighting systems, we will focus on patents that show the current state of the art related to energy saving techniques base on LEDs and that can be compared to the invention which is the motive for this application. U.S. Pat. No. 5,850,126 presents a screw in light bulb in a conventional form, made up of LEDs. The LEDs turn on and off at a set frequency and they manage currents higher than those they support. Said concept turns all the LEDs on and off and they remain turned off for a greater time than they are turned on, since the pulses that turn them on are smaller than those that keep them turned off By comparing this light bulb with the device presented in this application, we may describe an advantage in that the LEDs are controlled in such a way that we control the number of LEDs that are turned off or on, in such a way that illumination is maintained with the lower number of LEDs turned on and that this is imperceptible by the human eye, generating thus a lower consumption of energy.

U.S. Pat. No. 6,160,354 controls LEDs which are interconnected as a network, whose configuration and purpose are not lighting.

In addition to these patents, there is a concept known as PWM, (Pulse Width Modulation—by its English acronym) for managing LEDs, however, the use of said concept is for intensity effects and do not offer much in the way of energy savings given their focus. All these patents and applications give us a panorama of the current state of the art. However, in the patent documents mentioned, the focus is on using LEDs as an alternative source of lighting but the efforts do not focus on looking for efficient manners to use LEDs to save electricity. This invention is based on a design that makes it possible to use LEDs in an efficient manner, without significant losses in illumination, with which an even more substantial savings is obtained which may be more than 80% of the total consumption of the LEDs.

### DETAILED DESCRIPTION OF THE INVENTION

### Brief Description of the Figures

FIG. 1: Illustration Exterior of the lighting device to which this invention refers.

FIG. 2. Block Diagram of the lighting device in its Alternating Current (AC) variation.

FIG. 3. Block Diagram of the lighting device in its Direct Current (DC) variation.

FIG. 4: Schematic Diagram of the LED array.

FIG. 5: Schematic Diagram of the LED controller.

FIG. 6: Full Schematic Diagram of the Zener device without diodes.

FIG. 7: Full Schematic Diagram of the Zener device with diodes.

### FIGURES OF THE EXISTING ELEMENTS IN THE STATE OF THE ART

FIG. 8: Simple full wave bridge rectifier

FIG. 9: Schematic of a simple rectification.

FIG. 10: Schematic of a bridge rectification in parallel.

FIG. 11: DC-DC Converter.

### DESCRIPTION OF THE INVENTION

The invention described herein is a lighting device whose light source is made up of light emitting diodes (known as LED by its English acronym). This device may be connected to any conventional light bulb socket as well as being able to be connected to batteries powered by photovoltaic cells, or any direct current voltage source. The device may be in the form of any conventional light bulb, but its principal technological advantage with respect to other known or conventional light bulbs is that electronic scanning is used to turn them on for the purpose of obtaining low energy consumption.

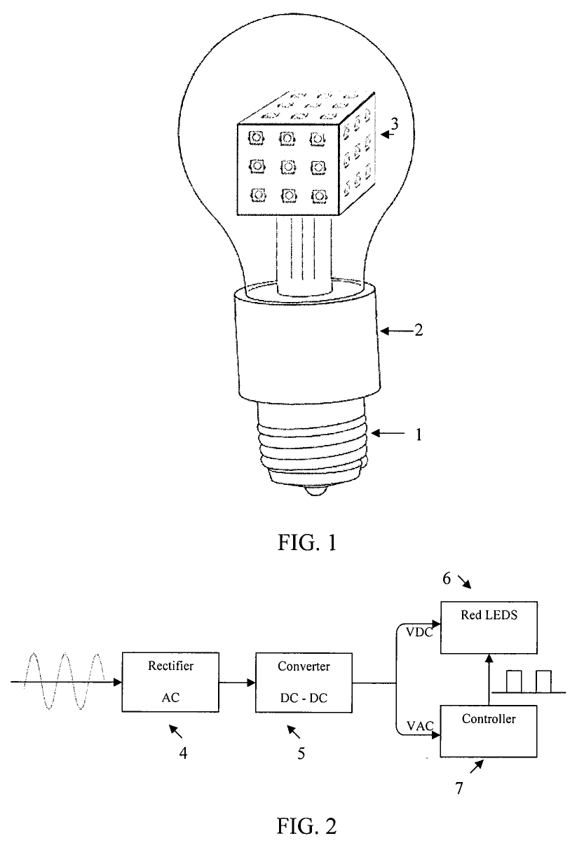

FIG. 1, shows the general diagram of the lighting device where it can be seen that it is made with a conventional screw-in light bulb (1), making it possible to connect it to a conventional socket. In the base (2) the controller is found with the necessary electronics to manage sequential lighting (scanning) of the LEDs as well as to provide the necessary voltage for its operation and within the cube (3) the printed circuits (PCBs) are found with the LED array. This invention has the versatility of a lighting device that is able to operate on Alternating Current (AC) as well as Direct Current (DC), i.e., it is possible to connect it to a residential, commercial, and/or industrial electric network or to a direct current source, such as a commercial type battery.

FIG. 2 shows a block diagram of the elements of the lighting device when it is connected to a residential electrical network, operating on the AC variation. Said device has a rectification stage for alternating current (AC) (4) the function of which is to rectify the current converting the alternating current into direct current and transforming the voltage to a constant value of DC-DC (5), obtaining thusly DCV and VAC voltage where the DCV voltage functions as the power source for the LED array (6) and the VAC voltage powers the controller (7), the function of which is to designate the lighting sequence of the LEDs.

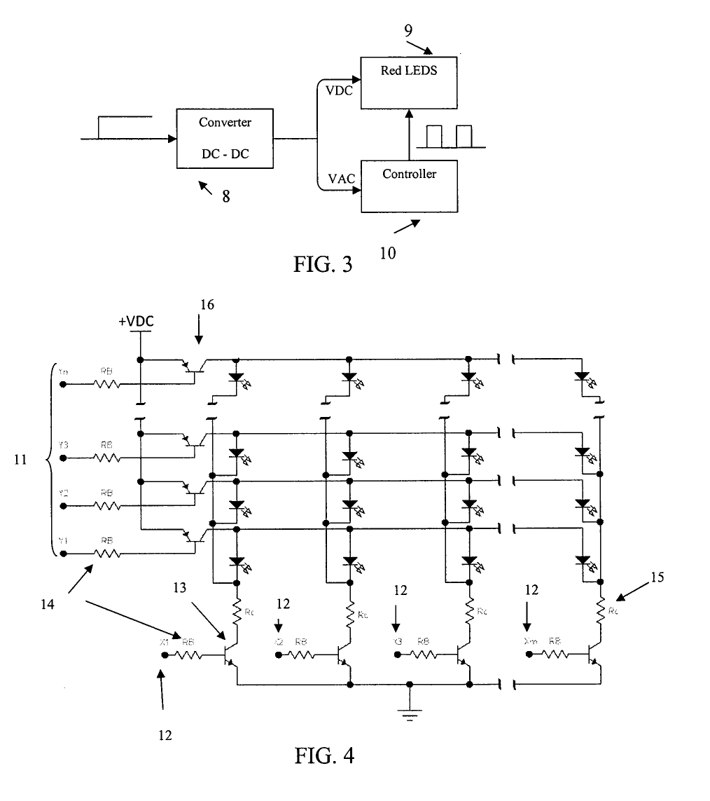

However, if the lighting device is powered by a DC source, the AC rectifying stage (4) is not used, giving as a result the device shown in the block diagram of the lighting device in its DC variation that is shown in FIG. 3 in which only the DC-DC converter (8) is required to produce VDC and VAC voltages where these voltages power the LED array (9) and the controller (10), respectively. The advantage of using this configuration with a DC source is that it is possible to power this device with alternate power sources such as solar, wind, among others.

One of the novelties of this invention is shown in FIG. 4 where an example of the preferred LED array may be seen forming a configuration similar to a network that contains columns and rows of LEDs.

In FIG. 4, the LED network may be seen that is made up of rows listed from Y1 to Yn (11) and by columns listed from X1 to Xm (12). It is important to mention that each column (X1 to Xm) has its own transistor (13) (in the case that BJT, NPN is used) which has an RB resistance (14) in its base, a GND is connected at its emitter or reference and in its collector an Rc resistance (15) is found. Additionally, each row (Y1 to Yn) also has its own transistor (16) (in the case that BJT or bipolar junction transistor, PNP, is used) which has an RB resistance (14) in its base, a VDD is connected at its emitter and from its collector a number of LEDs are connected which is equal to the number of columns that may range from “1” to “m”. In FIG. 4, the interconnection of the LEDs may be seen, where the columns, Xi are interlinked with the rows, Yi, the Rc resistance (15) sets the current that passes through the LED. It is important to point out that the model, family and characteristics of the transistors are neither definitive nor specific to the operation of the circuit.

To facilitate the explanation of the controller circuit (scanner) an example shall be shown setting “n” as well as “m” in 4, i.e., it will be explained as an array of 4 LEDs by 4 LEDs giving a total of 16 LEDs.

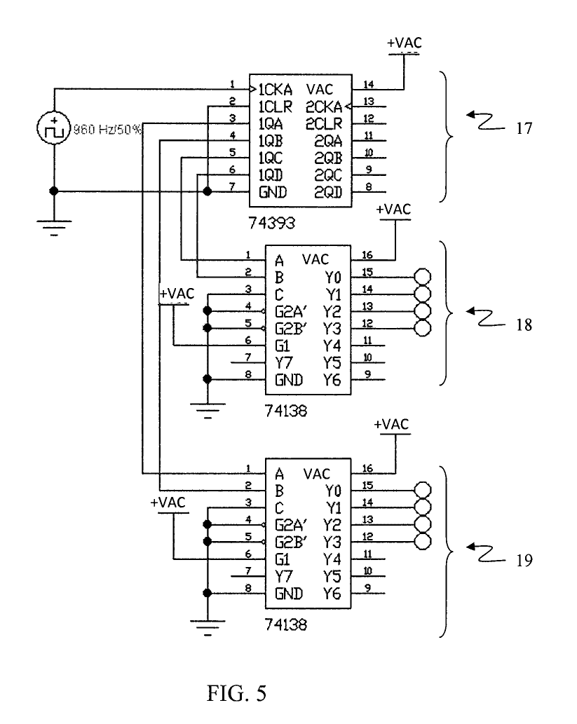

For addressing and selection of the LEDs the corresponding coordinate is activated, through the controller (7) and (10) which is described in detail in FIG. 5. In the specific case of 16 LEDs, these are selected through a calculation generated by a 4 bit binary counter. Addressing the 16 LEDs is achieved with these 4 bits because the LEDs are located as “rows” and “columns”.

For example, when Y4 and X4 are activated at the same time only the LED in the upper right corner will be turned on. If Y4 and X3 were the positions activated, only the preceding LED would be turned on. If only one column transistor is activated as well as another one from a row, only one LED will light at a time.

Said transistors in this example are activated with the controller from FIG. 5. Its function is to select only one row and one column at a time and after a certain time select another row-column pair until the entire “n by m” has been completed, 4 by 4 for example, and after it restarts its count. In the case of the example with 4 bit rows and columns, this controller is preferably implemented through a binary counter (17) connected to two decoders (18 and 19) as shown in FIG. 5, the specific components for the 16 bit example is specified later.

The decoder (19) used to select the columns (X1 to Xm); its outlets should be negated with an inverter to implement the proper control over the NPN transistor in the interconnection between the LED network and the controller. In addition, there is another decoder (18) for the rows, which is directly connected to the base of the PNP transistor, i.e., there so not require being inverted.

In this particular case, the scanning sequence first lights up LED by LED of the first row (Y1), and when it finishes, it does the same in the second row (Y2) and thus successively until it reaches the last row Yn (Y4 for the example) with the last column Xm (X4 for the example) and it starts again. However, the scanning sequence may adapt itself to different requirements being able to perform lighting in any order desired or even may be carried out in random order.

A binary counter provides counts that go up in multiples of 2, for example, 4, 6, 16, 32, and successively duplicating itself. For this circuit, a counter is used that may generate a count that is equal to or greater than the number of LEDs. The circuit design is expandable to a higher number of rows and columns (n by m), here only a small one is shown having 16 bits arranged 4 by 4 to facilitate the explanation, but the invention here proposed may use higher numbers of rows and columns, where the number of rows and columns are not necessarily equal.

The scan may be enlarged, with only one counter, in different forms, one of which is the following: the number of columns is determined in a multiple of 2, and the number of rows should also be thus. Afterwards, the number of bits that generate said counts are determined and linked, assigning a decoder to each count that has the lines necessary per column and if applicable, per row.

Generally speaking, a count of X bits divided into Y and Z bits is had, where Y+Z=X (Y:Z=X). A decoder is used for Y to 2^{Y} lines that is controlled by the bits called Y. Another decoder is used for Z to 2^{Z} lines that is controlled by the bits called Z. The circuit would control a total of 2^{X} LEDs that would light only one at a time. The count generated by the single decimal counter in the circuit would be the Z count.

Returning to FIG. 5, a schematic diagram of the 16 LED controllers is shown. The following components are shown in said diagram:
A 74393 binary counter (17) powered by a square signal generator with a frequency dependent upon the number of LEDs (60 Hz×# of LEDs or greater), in the example that is described herein would be 960 Hz (60 Hz×16). To said binary counter a pair of decoders is connected where the first of them is 74138, (18) and controls the rows, takes the most significant number of bits, and the second, the 74138 decoder (19) controls the columns, and takes the least significant number of bits. The second decoder's (19) outlet must be inverted to control the NPN transistors as mentioned above.

The control system requires two voltages, VAC and VDC; said voltages may be obtained from the AC network as well as from a DC source after being converted and regulated.

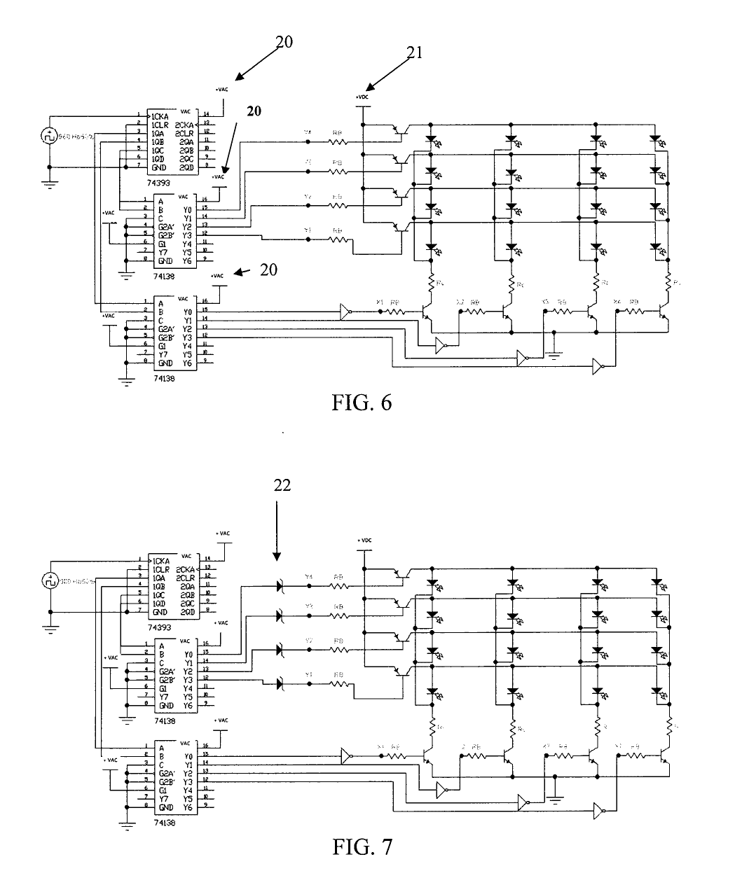

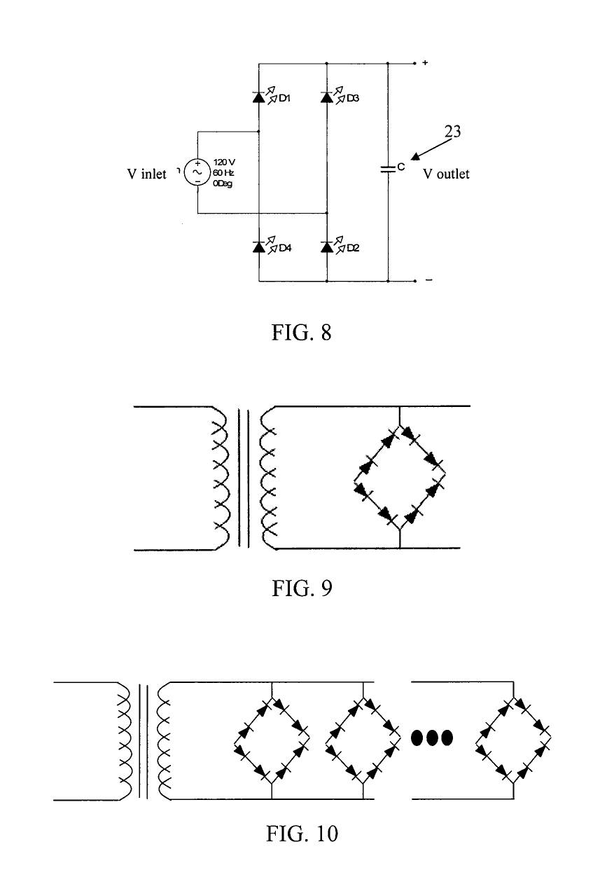

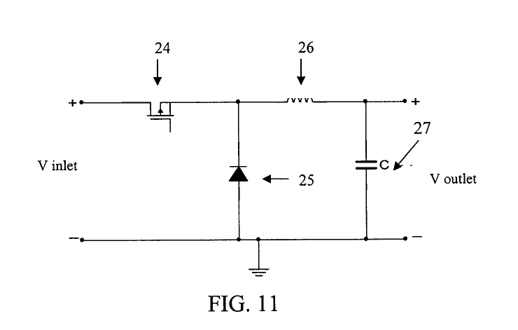

As illustrated in FIG. 6, the value of VAC 2(0) and VDC (21) may vary. By definition VAC is 5V and VDC will be set in accordance with the model, number, configuration, and type of LEDs and the voltage and/or current requirements. Said value may be equal to 5V for ease. If VAC is greater than or equal to VDC the schematic shown in FIG. 6 is used. Otherwise, see FIG. 7 which is the complete schematic diagram with Zener diodes (22); which is used if the VDC is greater than the VAC (5V), and that consists in that a Zener diode must be added to each row to protect the circuit.

As shown in FIG. 7. The value of said Zener diode (22) must be the same as the VDC minus the VAC rounded up to the nearest Zener commercial value and must be placed in such a way that it generates a fall in voltage in the direction of the base of the outlet transistor of the row decoder as shown in said Figure.

In summary, the scanning handles the selected lighting (scanning by rows and columns), alternate and consecutive of the individual LEDs or groups of LEDs that represent a fraction of the total LEDs in the lighting device.

Another of the important characteristics of this device is that the rectification phase is also made up by LEDs, which may be connected in the form of a full wave bridge rectifier FIG. (8), and in this way fulfills a double function of lighting and rectifying, achieving as a result low energy consumption since an extra rectifying phase (AC-AC) is not required to power the LED array and it also achieves greater illumination, the rectifier also may have variations using more LEDs in the bridge as can be seen in FIG. 9, or several bridges in parallel as shown in FIG. 10, which would allow for greater rectification and also take advantage of the use of the rectifying LEDs as a light and power source.

For the circuit rectification stage shown in FIG. 8 a typical rectifier is shown with a full wave diode bridge rectifier. Its purpose is to rectify the voltage of a light bulb socket (110 or 220 Volts AC to 60 or 50 Hz). This rectification is carried out using the four LEDs identified in the Figure as D1, D2, D3 and; D4; obtaining a pulsating voltage which is always positive. A capacitor (23) for converting the pulses into a constant voltage value is used, causing the rectifying circuit outlet to be DC voltage with no ripple, which passes to the DC-DC conversion stage.

This variation substitutes the diodes with light emitting diodes. In this invention, the above fulfills two functions: rectification of the sinoidal wave input (110 or 220 Volts CA) and at the same time the production of light, and for this reason it is able to use fewer LEDs during the scanning stage, and thus obtain greater energy savings. The frequency of oscillation is approximately constant, since it only depends on the frequency of the power outlet (50 or 60 Hertz).

The principal objective of the DC-DC conversion stage is to reduce the DC voltage that delivers the rectifier to a VDC voltage that is useful for the LED network, and which is determined according to the operational parameters of these. The basic circuit of this stage, shown in FIG. 11, consists of a DC-DC converter, known as a “chopper” reducer. This circuit is basically made up of a transistor (24), a diode (25), and an inducer (26), the objective of which is to maintain a relatively constant current to the circuit outlet. The transistor (24) makes it possible, through a trigger circuit, to decide what percentage of the input voltage (V input) is transmitted to the output, which makes it possible to vary the average output voltage as desired. Given that the output voltage is a pulsating square voltage, a capacitor (27) is used to make a constant V output. For technical reasons it is necessary to place several of these circuits in cascade.

At the output of these two stages, the voltage obtained is that required for proper operation of the LED array. The values of the components and the number of circuits that must be placed in cascade for the DC-DC conversion stage is determined by the parameters of VDC voltage and the current required for the LED array. When the VDC voltage is not equal to that required for VAC (for example 5 volts), a circuit with a built-in commercial voltage regulator may be used.

1. A lighting device with low energy consumption activated by electronic scanning, characterized by selectively, sequentially, and alternatively powered by a lighting element network, matrix configured in rows and columns listed from Y1 to Yn (11) and from X1 to Xm (12) respectively, where the rows and columns are powered through a controller that generates decimal counts generated by one or more binary counters and one or more decoders at a set frequency preferably of 60 hz multiplied by the number of lighting elements or groups of lighting elements to be controlled; the lighting element network and the controller are powered by a rectification phase and by a DC-DC conversion stage, in the case in which the lighting device is connected to Alternating Current (AC); in the case in which the lighting device is connected to a direct current source, this would only connect to the DC-DC conversion stage without the AC-AC rectification stage.

2. The lighting device with low energy consumption activated by electronic scanning, in accordance with claim 1, characterized in that the lighting elements are preferably LEDs.

3. The lighting device with low energy consumption activated by electronic scanning, in accordance with claim 1, characterized in that the arrangement in the LED network has a transistor array that are able to perform switching to the LEDs, said LED array consists of a network with a focus similar to that of a plot grid, which has “m” columns and “n” rows.

4. The lighting device with low energy consumption activated by electronic scanning, in accordance with claim 3, characterized in that the LED network presents a net type of arrangement in which each column has its own transistor (in the case where a BJT, NPN is used) which has an RB resistance in its base, a GND or reference is connected at its emitter and an Rc resistance is found in its collector; each row has its own transistor (in the case where transistors from the BJT, PNP family are used) which has an RB resistance in its base, VDC is connected to its emitter and a number of LEDs equal to the number of columns is connected to its collector; each of these LEDs is connected to the Rc of the columns; also transistors may be used from other families for the same purpose, the transistor model is not definitive or specific.

5. The lighting device with low energy consumption activated by electronic scanning, in accordance with claim 3, characterized in that the LEDs in each row (Y1 to Yn) has its own transistor (16) (in the case where a BJT or bipolar juncture transistor, PNP is used) which has an RB resistance (14) in its base, VDC is connected to its emitter and from its collector a number of LEDs are connected which is equal to the number of columns that may range from “1” to “m”.

6. The lighting device with low energy consumption activated by electronic scanning, in accordance with claim 1, characterized in that the controller for selecting and powering the LED network uses a counter with a count of X bits that is divided in Y and Z bits, where Y+Z=X (Y:Z=X) and uses a decoder for Y to 2^{Y} lines that is controlled by the bits called Y; another decoder is used for Z to 2^{Z} lines that is controlled by the bits called Z; the circuit would control a total of 2^{X} LEDs that would light only one at a time; said addressing to the LED network may be accomplished in two ways, an efficient manner to do this is shown herein.

7. The lighting device with low energy consumption activated by electronic scanning, in accordance with claim 6 characterized in that the decoder used to select the rows, will carry the addition of a Zener diode if the voltage called VDC is greater than the VAC, which powers the built-in circuits; the value of each Zener diode shall be the VDC minus the VAC to generate a fall in voltage towards the base of the transistor, in this case, PNP, to the outlet of the row decoder. If the VDC is not greater than the VAC, said Zener diode will not be added.

8. Lighting device with low energy consumption activated by electronic scanning, in accordance with claim 1, characterized in that in the case in which the device operates with alternating current, a full wave rectification phase will be used replacing the normal diodes with LEDs, which makes the system have a low energy consumption as well as the fact that the rectifier bridge will also function as lighting, increasing in this way the intensity of the light generated by the device.

9. The lighting device with low energy consumption activated by electronic scanning, in accordance with claim 8, characterized in that the rectification phase is made up by the LEDs that are connected in the form of a full wave bridge rectifier, powered by variable voltage, but the rectifier may have variations using more LEDs in the bridge, or several rectifying bridges in parallel to perform greater rectification and to take advantage of the use of the LEDs as a light and power source.

10. The lighting device with low energy consumption activated by electronic scanning, in accordance with claim 8, characterized in that the wave form of the voltage power signal is not only confined to the sinoidal form (available in the majority of the power outlets in the world with frequencies between 50 Hz and 60 Hz) but this invention has been created in such a way that any wave form in which light emitting diodes (LEDs) full wave bridge rectifier may be used for its rectification.

11. Lighting device with low energy consumption activated by electronic scanning, in accordance with claim 1, characterized in that among its multiple uses it may be used as a conventional light bulb, or as a source of direct current to produce lighting.

12. Lighting device with low energy consumption activated by electronic scanning, in accordance with claim 2, characterized in that among its multiple uses it may be used as a conventional light bulb, or as a source of direct current to produce lighting.

13. Lighting device with low energy consumption activated by electronic scanning, in accordance with claim 3, characterized in that among its multiple uses it may be used as a conventional light bulb, or as a source of direct current to produce lighting.

14. Lighting device with low energy consumption activated by electronic scanning, in accordance with claim 4, characterized in that among its multiple uses it may be used as a conventional light bulb, or as a source of direct current to produce lighting.

15. Lighting device with low energy consumption activated by electronic scanning, in accordance with claim 5, characterized in that among its multiple uses it may be used as a conventional light bulb, or as a source of direct current to produce lighting.

16. Lighting device with low energy consumption activated by electronic scanning, in accordance with claim 6, characterized in that among its multiple uses it may be used as a conventional light bulb, or as a source of direct current to produce lighting.

17. Lighting device with low energy consumption activated by electronic scanning, in accordance with claim 7, characterized in that among its multiple uses it may be used as a conventional light bulb, or as a source of direct current to produce lighting.

18. Lighting device with low energy consumption activated by electronic scanning, in accordance with claim 8, characterized in that among its multiple uses it may be used as a conventional light bulb, or as a source of direct current to produce lighting.

19. Lighting device with low energy consumption activated by electronic scanning, in accordance with claim 9, characterized in that among its multiple uses it may be used as a conventional light bulb, or as a source of direct current to produce lighting.

20. Lighting device with low energy consumption activated by electronic scanning, in accordance with claim 10, characterized in that among its multiple uses it may be used as a conventional light bulb, or as a source of direct current to produce lighting.
